(19) United States
(12) Patent Application Publication
(10) Pub. No.: US 2020/0387748 A1
(43) Pub. Date: Dec. 10, 2020

(54) FACIAL IMAGE DATA COLLECTION METHOD, APPARATUS, TERMINAL DEVICE AND STORAGE MEDIUM

(71) Applicant: Ping An Technology (Shenzhen) Co., Ltd., Shenzhen, Guangdong (CN)

(72) Inventors: Zhibo Zhu, Shenzhen, Guangdong (CN); Weijie Chen, Shenzhen, Guangdong (CN); Shanpeng Wu, Shenzhen, Guangdong (CN)

(21) Appl. No.: 16/088,828

(22) PCT Filed: Jan. 30, 2018
(86) PCT No.: PCT/CN2018/074575

§ 371 Date: Sep. 27, 2018

(30) Foreign Application Priority Data
Aug. 17, 2017 (CN) 201710706509.1

(51) Int. Cl. G06K 9/62; G06K 9/00; G06F 16/951

(52) U.S. Cl. CPC G06K 9/6256; G06F 16/951; G06K 9/00275; G06K 9/00228

(57) ABSTRACT

This application discloses a facial image data collection method, apparatus, terminal device and storage medium. The facial image data collection method includes: crawling an original image from a network by using an image crawler tool; recognizing the original image to obtain an effective image containing face features by using a face recognition algorithm; and cutting out a target facial image from the effective image by using a preset selection box. The facial image data collection method can quickly collect a large amount of facial images.

The patent application is based on a Chinese invention patent application entitled “facial image data collection method, apparatus, terminal device, and storage medium” with an application number of 201710706509.1 filed on Aug. 17, 2017 and claims its priority.

### TECHNICAL FIELD

The present application relates to the field of image processing technologies, and in particular, to a facial image data collection method, apparatus, terminal device, and storage medium.

### BACKGROUND

Face recognition technology is a kind of biometric recognition technology for human identification based on human facial feature information. Face recognition technology specifically uses a camera or a webcam to capture an image or a video stream containing a face, and uses a face recognition model to automatically detect the face in the image or video stream, and then performs face recognition on the detected face. With the development and popularization of face recognition technology, it is necessary to collect a large amount of facial image data to train the face recognition model so as to improve the face recognition accuracy of the face recognition model. The current facial image data collection process requires a lot of manpower and material resources, thereby resulting in high cost and low efficiency.

### SUMMARY OF THE INVENTION

The present application provides a facial image data collection method, apparatus, terminal device, and storage medium to solve the problem of low efficiency of the current facial image data collection process.

In the first aspect, the present application provides a facial image data collection method, including:

using an image crawler tool to crawl an original image from a network;

using a face recognition algorithm to recognize the original image and obtaining an effective image containing face features; and

using a preset selection box to cut out a target facial image from the effective image.

In a second aspect, the present application provides a facial image data collection apparatus including:

an original image crawling module configured to use an image crawler tool to crawl an original image from a network;

an effective image recognition module configured to use a face recognition algorithm to recognize the original image and obtain an effective image containing face features; and an effective image cutting module configured to use a preset selection box to cut out a target facial image from the effective image.

In a third aspect, the present application provides a terminal device including a storage, a processor, and computer readable instructions stored in the storage and executable on the processor, wherein the processor executes the computer readable instructions to implement following steps:

using an image crawler tool to crawl an original image from a network;

using a face recognition algorithm to recognize the original image and obtaining an effective image containing face features; and

using a preset selection box to cut out a target facial image from the effective image.

In a fourth aspect, the present application provides a computer readable storage medium storing computer readable instructions, the computer readable instructions, when executed by a processor, implement following steps:

using an image crawler tool to crawl an original image from a network;

using a face recognition algorithm to recognize the original image and obtaining an effective image containing face features; and

using a preset selection box to cut out a target facial image from the effective image.

Compared with the prior art, the present application has the following advantages: In the facial image data collection method, apparatus, terminal device, and storage medium provided by the present application, the original image can be crawled from the network by an image crawler tool. A large amount of original images can be automatically captured from the network according to a certain rule, and the data collection speed is fast. Then the face recognition algorithm is used to recognize the original image to obtain the effective image containing face features, so that the original image without face features is not used as an effective image, thereby ensuring that the collected effective image can be applied to face recognition model training to improve effectiveness and accuracy of the face recognition model training. The preset selection box is then used to cut out the target facial image from the effective image, so that when the collected target facial image is applied to the face recognition model training, accuracy of the face recognition model can be effectively improved.

### BRIEF DESCRIPTION OF THE DRAWINGS

In order to more clearly explain the technical solutions in the present application, the drawings to be used in the description of the embodiments or the prior art will be briefly described below. Obviously, the drawings in the following description are only some implementations of the present application. One ordinary skill in the art can obtain other drawings based on these drawings without paying any creative labour.

FIG. 1 is a flowchart of a facial image data collection method according to embodiment 1;

FIG. 2 is a specific flowchart of step S10 in FIG. 1;

FIG. 3 is a specific flowchart of step S20 in FIG. 1;

FIG. 4 is another specific flowchart of step S20 in FIG. 1;

FIG. 5 is a specific flowchart of step S30 in FIG. 1;

FIG. 6 is a schematic block diagram of a facial image data collection apparatus according to embodiment 2; and

FIG. 7 is a schematic block diagram of a terminal device according to embodiment 4.

### DETAILED DESCRIPTION

In the following description, for the purpose of explanation rather than limitation, specific details such as specific system configurations, techniques, etc. are set forth in order to provide a thorough understanding of the present application. However, it will be apparent to those skilled in the art that the present application may be practiced in other embodiments without these specific details. In other instances, detailed descriptions of well-known systems, apparatuses, circuits, and methods are omitted to avoid obscuring the description of the present application with unnecessary details.

### Embodiment 1

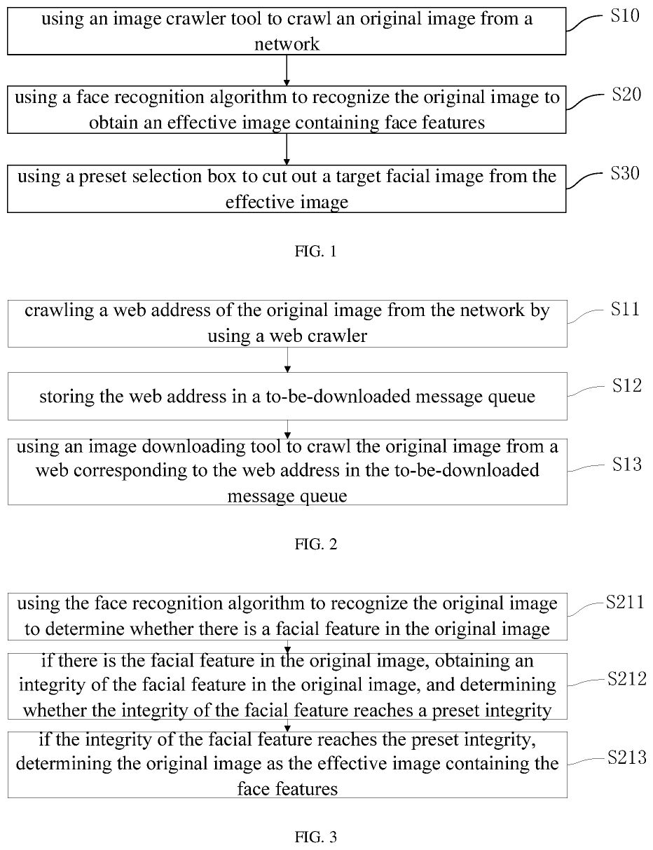

FIG. 1 shows a facial image data collection method in this embodiment. The facial image data collection method can quickly collect a large amount of facial image data from the network, so as to perform face recognition model training based on the collected facial image data. As shown in FIG. 1, the facial image data collection method includes the following steps.

S10: Using an Image Crawler Tool to Crawl an Original Image from a Network

In the step, the image crawler tool is a program that can automatically crawl a web address of a web containing images, and download images based on the crawled web address. The image crawler tool only crawls images in the network without crawling other data. It is more targeted and facilitates improving image collection efficiency. The original image is an image downloaded from the web using the image crawler tool. In this embodiment, the image crawler tool can be used to download a large amount of original images from a social network, a search engine, or other websites. The amount of data is large and the acquisition process is simple and convenient.

Specifically, the image crawler tool includes a web crawler and an image downloading tool. The web crawler and the image downloading tool may be integrated as a whole or set separately, wherein the web crawler is a program or script that automatically captures internet information according to certain rules, while the image downloading tool is a program or script that automatically downloads images from the internet based on the input web address. In this embodiment, the image crawler tool may use a distributed image crawler tool, such as a python image crawler tool. The python image crawler tool may implement parallel capturing of the original image to improve the crawling efficiency of the original image, wherein the python image crawler tool integrates a web crawler and an image downloading tool.

In a specific embodiment, as shown in FIG. 2, step S10 specifically includes the following steps.

S11: Crawling a Web Address of the Original Image from the Network by Using a Web Crawler

In the step, the web address (Uniform/Universal Resource Locator, or URL) is a standard resource address on the internet, and is an address of a web where the original image is located. In this embodiment, the web crawler automatically crawls the web address including the original image from the internet according to the crawling task set by the user, and no manual search is required, which facilitates improving data collection efficiency.

Further, crawling the web address of the original image from the network by using the web crawler specifically includes the following steps.

Firstly, a crawling task is set in the web crawler. The crawling task includes the original web address, a paging rule, and a keyword, wherein the original web address is a user-defined web address from which to start the crawling task. The paging rule is a user-defined rule for paging the web. It can be set according to the actual source of the data. In the setting process, a fixed format or an unfixed format may be used. A keyword is a word that the web crawler searches during crawling network addresses. The keyword may be a word obtained by the user after clustering the historical data, so that the probability of searching for the acquired effective image based on the keyword is high. For example, if the keyword is “self-photographing”, the probability of the acquired effective image containing face features is high.

Secondly, the web crawler performs the crawling task to capture the web address containing the original image based on the paging rule and the keyword from an original web address. In this embodiment, a preset search strategy may be used to continuously crawl a new web address from the current web into a to-be-downloaded message queue, and the execution of the crawling task is not stopped until a preset stop condition is satisfied. The preset search strategy includes, but is not limited to, a breadth-first search strategy or a depth-first search strategy used in this embodiment.

S12: Storing the Web Address in a to-be-Downloaded Message Queue

Specifically, the web address of each original image that is crawled in step S11 is stored in the to-be-downloaded message queue according to the chronological order of crawling, so that when step S13 is performed, image downloading can be performed based on the web address in the to-be-downloaded message queue. The to-be-downloaded message queue processes the web address in a First-In-First-Out manner, so that it can asynchronously process the crawling of the web address and the downloading of the original image based on the web address, which facilitates improving the efficiency of obtaining the original image.

S13: Using an Image Downloading Tool to Crawl the Original Image from a Web Corresponding to the Web Address in the to-be-Downloaded Message Queue

In the step, the image downloading tool is a tool for downloading images in batches, and can automatically download all the images in the web corresponding to the inputted web address. The image downloading tool can be integrated in an image crawler tool. For example, python image crawler tool integrates with an image downloading tool. The image downloading tool can also be an independent image downloading tool, such as NeoDownloader tool. It can quickly download images in batches.

In this embodiment, a plurality of web addresses including original images are stored in the to-be-downloaded message queue, and the image downloading tool sequentially acquires the web addresses from the to-be-downloaded message queue and downloads the original image corresponding to the web address. Specifically, the image downloading tool obtains a web address from the head of the queue to be downloaded, downloads the image in the web address, stores the downloaded original image in the database, and deletes the corresponding web address in the to-be-downloaded message queue. The above steps are repeated until there is no web address in the to-be-downloaded message queue, so that the original images corresponding to all web addresses crawled by the image crawler tool are obtained.

In this embodiment, the web address of the original image crawled by the web crawler is stored in the to-be-downloaded message queue, and then the original image is downloaded using the image download tool based on the web address obtained in the to-be-downloaded message queue, so that the web address downloading and the original image downloading can be asynchronously processed, which facilitates improving the efficiency of obtaining the original image.

S20: Using a Face Recognition Algorithm to Recognize the Original Image and Obtaining an Effective Image Containing Face Features

Since the original image downloaded from the network by using a web crawler may be an image including face features, or an image not including face features, if the face recognition model training is directly performed based on the collected original image, the original image without face features will affect the accuracy and efficiency of the face recognition model training. Therefore, the face recognition algorithm is required to recognize the original image to extract the effective image containing the face features; so that face recognition model training can be performed based on the effective image, which can improve the accuracy and efficiency of face recognition model training, wherein, the face recognition algorithm is an algorithm for identifying face features in an image. In this embodiment, a face recognition program is preset, and a face recognition algorithm is stored in the face recognition program. When the face recognition program is executed by the processor, the face recognition algorithm may be used to perform face recognition on the original image, so as to get an effective image containing the face features.

Specifically, the original image downloaded from the network by using the image crawler tool is buffered in the database, and the storage address of the original image in the database is put into a message queue to be identified, and a face recognition program is executed to obtain the corresponding original image based on the storage address in the message queue to be identified in sequence. The original image is recognized by using a face recognition algorithm to determine whether the original image includes face features. If the original image includes face features, the original image is determined to be an effective image and saved; if the original image does not contain the face features, it is determined that the original image is not an effective image, and the original image buffered in the database is deleted, so as to save the storage space of the database.

In this embodiment, the face recognition algorithm may be a face recognition algorithm based on geometric features, a face recognition algorithm based on eigenfaces, a face recognition algorithm based on elastic models, or a face recognition algorithm based on neural networks, wherein, the face recognition algorithm based on geometric features is a method for face recognition by extracting the geometric features of eyes, ears, mouth, nose, and eyebrows as classification features. The face recognition algorithm based on eigenfaces is a method for face recognition by constructing the main element subspace from a set of face training images. When the recognition is preformed, the original image is projected onto the main element subspace to obtain a set of projection coefficients. Face features are identified by comparing the projection coefficients and respective facial images. The main element has a face shape and is called an eigenface. The face recognition algorithm based on the elastic models is a method describing an object with sparse graphics where its vertex represents the multi-scale description of the local energy and its edge represents the topological connection and is marked with the geometric distance and then finding the closest known graphics by using the plastic pattern matching technology. The face recognition algorithm based on Neural Networks is a method for face recognition by using a nonlinear dynamics system that includes extracting multiple main elements, using an autocorrelation neural network to map them into a multidimensional space, and using a multi-layer perceptron to make a judgement. This method has a good self-organization and self-adaptive ability.

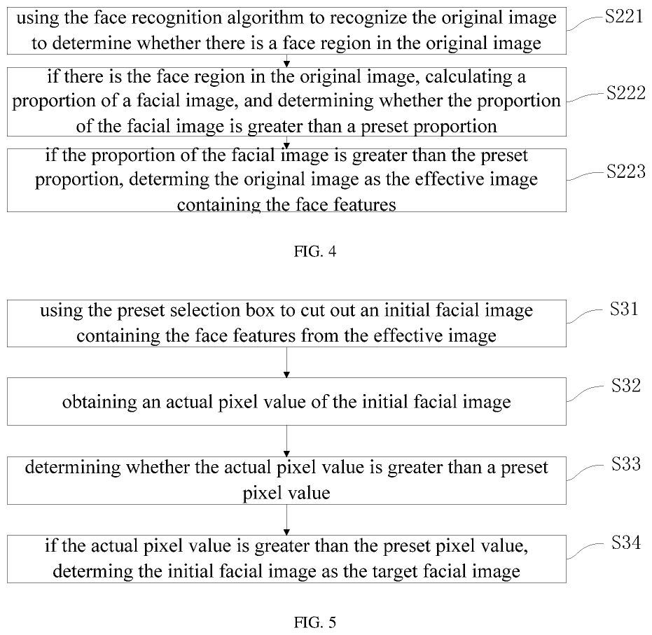

In a specific implementation, as shown in FIG. 3, step S20 specifically includes the following steps:

S211: Using the Face Recognition Algorithm to Recognize the Original Image to Determine Whether there is a Facial Feature in the Original Image

In the step, the facial feature is one of the face features, including features of the eyes, ears, mouth, nose, and eyebrows. In this embodiment, an eigenface-based face recognition algorithm may be used to identify the original image to determine whether there are facial features in the original image. Specifically, the following steps are included: firstly, an active appearance model (AAM) is used to detect the portraits and the feature vectors of the facial features in the original image. Secondly, Principal Component Analysis (PCA) is used to extract the feature vectors of the facial features and simultaneously reduce the data dimension to extract the main feature vectors. Using PCA to reduce the dimension can reduce the computational burden. Then, the K-means method is used to classify the feature vectors after PCA processing, which can realize simple and fast classification. Finally, a support vector machine (SVM) is used to train the K categories of data to obtain a classification model, so as to identify whether the original image contains facial features based on the classification model.

In the present embodiment, a face recognition algorithm is used to identify the original image. If a facial feature is identified in the original image, step S212 is performed; if no facial features are identified in the original image, the original image is not an effective image including face features. The original image will be deleted to save the database storage space.

S212: If there is the Facial Feature in the Original Image, Obtaining an Integrity of the Facial Feature in the Original Image, and Determining Whether the Integrity of the Facial Feature Reaches a Predetermined Integrity

In the step, the integrity of the facial feature is a ratio of the facial feature identified in the original image to the complete facial feature. The integrity of the facial feature=organ weight*organ integrity. The organs include eyes, ears, mouth, nose, and eyebrows, wherein, the organ integrity refers to the integrity of the five organs of eyes, ears, mouth, nose, and eyebrows, and the integrity of the organs is a ratio of the organs identified in the original image to the complete organs. The organ weight is a user-predefined weight constant, and the organ weight can be set according to the distance of an organ from the center of the face. As in the present embodiment, the distance from the nose to the center of the face is the smallest, and the weight of the nose is the largest; accordingly, the distance from the ears to the center of the face is the largest, and the weight of the ears is the smallest. If an organ is completely displayed in the original image, the integrity of the organ is 100%. If only a half of an organ is displayed in the original image, the integrity of the organ is 50%. The predetermined integrity is a reference value preset by the user for evaluating the completeness of the facial features. The predetermined integrity is defined by the user and may be set to 80% or other values.

S213: If the Integrity of the Facial Feature Reaches the Predetermined Integrity, Using the Original Image as the Effective Image Containing the Face Features

It can be understood that if the integrity of the facial feature of the original image reaches the predetermined integrity, the facial feature in the original image is considered to be complete. That is, the original image contains complete facial features and can be saved as an effective image. On the other hand, if the integrity of the facial feature does not reach the predetermined integrity, the facial feature in the original image is considered to be incomplete.

The original image cannot be used as the training data of the face recognition model and will be deleted to save the database storage space. In this embodiment, if there is a complete face in the original image, the integrity of the facial features is 100%, exceeding the predetermined integrity of 80%, the original image is saved as a effective image; if there is only a half of the face in the original image, the integrity of its facial features is 50%, not reaching the predetermined integrity of 80%, it is determined that the original image is not an effective image, and the original image is deleted to save the storage space of the database.

In another specific implementation, as shown in FIG. 4, step S20 specifically includes the following steps:

S221: Using the Face Recognition Algorithm to Recognize the Original Image to Determine Whether there is a Face Region in the Original Image

In the step, the face region is the face feature above the human neck, and the face region includes not only five organs such as eyes, ears, mouth, nose, and eyebrows, but also features such as the color of the face and the expression of the face. In this embodiment, face recognition algorithms such as a face recognition algorithm based on geometric features, a face recognition algorithm based on eigenfaces, a face recognition algorithm based on an elastic model, or a face recognition algorithm based on neural networks may also be used to recognize the face region.

Specifically, a face recognition algorithm based on BP neural network (Back Propagationr Neural Networks, hereinafter referred to as BP neural network) is used to identify the original image. BP neural network is a forward network and generally includes an input layer, a hidden layer, and an output layer. The hidden layer can be one layer, two layers or even more layers to facilitate the analysis of the interactions between various factors. Each layer is composed of several neurons, and each neuron in the adjacent two layers has a weigh to communicate with each other. The magnitude of the weight reflects the strength of the connection between two neurons. The calculation of the entire network is a one-way process from the input layer to the hidden layer, and then to the output layer. In essence, a BP neural network is a mapping of input to output by learning a large amount of mappings between inputs and outputs. The process of recognizing the original image by using a face recognition algorithm based on the BP neural network specifically includes the following steps: (1) performing image preprocessing such as image compression, image sampling, and input vector normalization on the original image to obtain image features, wherein, the image compression uses an interpolation algorithm such as near-interpolation, bilinear interpolation or bi-cubic interpolation to compress the original image, so as to avoid a large amount of redundant information in the original image resulting in the BP neural network structure being too complicated. Image sampling is to compile the compressed two-dimensional image matrix line by line into a one-dimensional column vector to facilitate the input of the subsequent BP neural network. The input vector normalization is to normalize the one-dimensional column vectors obtained by the image sampling to avoid the large value of the one-dimensional column vector, which affects the calculation efficiency and the convergence rate. (2) The acquired image features are input into the input layer of the BP neural network, and through the processing of the hidden layer, the output layer outputs the probability of the the original image including the face region. (3) Comparing the acquired probability of the the original image including the face region with a preset probability; if the probability of the the original image including the face region is greater than the preset probability, it is considered that the face region exists in the original image; If the probability of the original image including the face region is not greater than the preset probability, it is considered that there is no face region in the original image, wherein, the preset probability is a user-defined probability of evaluating whether there is a face region in the original image.

In this embodiment, a face recognition algorithm is used to recognize the original image. If it is recognized that the original image has a face region, step S222 is performed; if it is recognized that the original image does not have a face feature, the original image is not an effective image containing face features. The original image will be deleted to save the storage space of the database.

S222: If there is the Face Region in the Original Image, Calculating a Proportion of a Facial Image, and Determining Whether the Proportion of the Facial Image is Greater than a Preset Proportion

In the step, the proportion of the facial image refers to a ratio of the size of the image corresponding to the face region to the size of the original image. In this embodiment, the face region may be defined by a rectangular box, and the size of the image corresponding to the face region is the area of the rectangular box. Correspondingly, the size of the original image is the area of the original image. That is, the preset proportion is a ratio of the area of the face region to the area of the original image. The preset proportion is a user-preset proportion for evaluating whether that the original image is an effective image. The preset proportion is a reference value which can be defined by the user.

S223: If the Proportion of the Facial Image is Greater than the Preset Proportion, Using the Original Image as the Effective Image Containing the Face Features

It can be understood that if the proportion of the facial image is greater than the preset proportion, the original image is determined to be an effective image containing face features. If the proportion of the facial image is not greater than the preset proportion, the area of the face region in the original image is too small. If the original image is used as the training data of the subsequent face recognition model, the accuracy and training efficiency of the face recognition model training may be affected. Therefore, the original image of which the proportion of the facial image is too small is not used as an effective image, and will be deleted to save the storage space of the database.

In this embodiment, steps S211-S213 may be used to determine whether the original image is an effective image containing face features by comparing the integrity of the facial features and the predetermined integrity. Steps S221-223 may also be used, that is, it is determined whether the original image is an effective image containing face features by comparing the proportion of the facial image with the preset proportion. These two methods of judgement can improve the accuracy of the acquired effective image for subsequent face recognition model training at some extent. It can be understood that steps S211-S213 and steps S221-S223 can also be combined, that is, the comparison of the integrity of the facial features and the predetermined integrity and the comparison of the proportion of the facial image and the preset proportion can be sequentially completed. When the two conditions are satisfied, the original image can be identified as an effective image, so that when the face recognition model is trained based on the effective image, the accuracy of the subsequent face recognition model training can be further improved.

S30: Using a Preset Selection Box to Cut Out a Target Facial Image from the Effective Image

The preset selection box is a user-defined selection box for cutting out an image from an effective image, and the preset selection box may be a rectangular box. Since the effective image acquired in step S20 includes a region where the face features are located and a non-face region other than the face features, and the face recognition model generally focuses only on the face features in the effective image and does not necessarily pay attention to the non-face region during training, the training accuracy of the model may be affected if an effective image including a non-face region is directly trained on a face recognition model. Therefore, a preset selection box may be used to cut out the image containing the face features from the effective image. That is, a part of the effective image where the face features are located are cut out by the preset selection box to obtain the target facial image and save it, so as to improve the accuracy of subsequent face recognition model training based on the target facial image.

In a specific embodiment, as shown in FIG. 5, step S30 specifically includes the following steps:

S31: Using the Preset Selection Box to Cut Out an Initial Facial Image Containing the Face Features from the Effective Image

In the step, the initial facial image is an image obtained by cutting an effective image. A preset selection box is used to select the part where the face feature is located in the effective image, and a screenshot operation is performed to cut out the initial facial image containing the face features. In this embodiment, the center position of the face features in the effective image is captured, and the center position is overlapped with the center of the preset selection box to determine the position of the face feature to be cut out, and then the screenshot operation is performed to obtain the initial facial image.

S32: Obtaining an Actual Pixel Value of the Initial Facial Image

It may be understood that if the initial facial image acquired in step S31 is directly used as training data of the face recognition model, the training accuracy and efficiency of the face recognition model may be affected when the initial facial image pixel is low. The actual pixel value of the initial facial image needs to be determined during image acquisition to determine whether the initial facial image can be used as training data of the face recognition model training. In this embodiment, the RBG value in the initial facial image may be calculated by using Matlab or OpenCV to obtain the actual pixel value of the initial facial image.

S33: Determining Whether the Actual Pixel Value is Greater than a Preset Pixel Value

The preset pixel value is a pixel value required for training an image as a face recognition model, and the preset pixel value is a pixel reference value customized by the user according to requirements. The larger the preset pixel value is, the less images are collected to meet the condition of the preset pixel value, the higher the accuracy and efficiency of the face recognition model training is. Conversely, the smaller the preset pixel value is, the more images are collected to meet the condition of the preset pixel value, and the lower the accuracy and efficiency of the face recognition model training is. Therefore, the preset pixel value needs to be set appropriately.

S34: If the Actual Pixel Value is Greater than the Preset Pixel Value, Using the Initial Facial Image as the Target Facial Image

Understandably, if the actual pixel value of the initial facial image is greater than the preset pixel value, it is determined that the initial facial image reaches the pixel value required for the face recognition model training, and the initial facial image is output as the target facial image. On the other hand, if the actual pixel value of the initial facial image is not greater than the preset value, the actual pixel value of the initial facial image is determined to be too low. If the initial facial image is used to train the face recognition model, the accuracy and effectiveness of the face recognition model training will be affected. Therefore, the original image corresponding to the initial facial image should be deleted to save the storage space of the database.

Further, before step S31, the method further includes the following steps: scaling the effective image so that the size of the region where the face features of the effective image is located matches the size of the preset selection box, and the preset selection box in step S31 is used to cut out the initial facial image of which the size is appropriate to facilitate the improvement of the accuracy of subsequent face recognition model training based on the target image.

In the facial image data collection method provided by the present application, a large amount of original images can be crawled from the network by using an image crawler tool and the data collection speed is fast. The face recognition algorithm is used to recognize the original image to obtain the effective image containing face features, so that the original image without face features is not used as an effective image, thereby ensuring that the collected effective image can be applied to face recognition model training to improve effectiveness and accuracy of the face recognition model training. The preset selection box is then used to cut out the target facial image from the effective image, so that when the collected target facial image is applied to the face recognition model training, accuracy of the face recognition model can be effectively improved.

It should be understood that the sequence number in each step in the foregoing embodiment does not mean the order of the execution sequence, and the execution sequence of each process should be determined by its function and inherent logic, and should not constitute any limitation on the implementation process of the present application.

### Embodiment 2

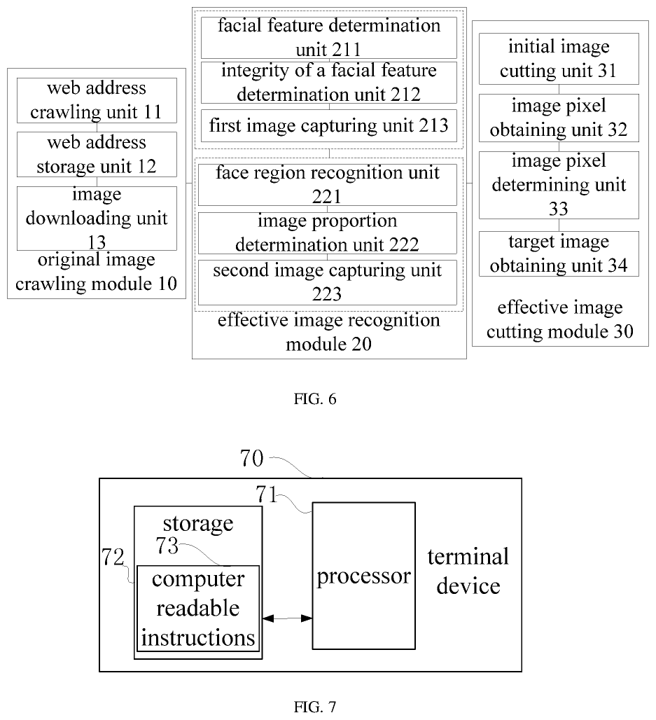

Corresponding to the facial image data collection method in Embodiment 1, FIG. 6 shows a facial image data collection apparatus corresponding to the facial image data collection method shown in Embodiment 1. As shown in FIG. 6, the facial image data collection apparatus includes an original image crawling module 10, an effective image recognition module 20, and an effective image cutting module 30. The implementation functions of the original image crawling module 10, the effective image recognition module 20, and the effective image cutting module 30 are in one-to-one correspondence with the corresponding steps in Embodiment 1, which is not described again herein so as to avoid repetition.

The original image crawling module 10 is configured to use an image crawler tool to crawl an original image from a network.

The effective image recognition module 20 is configured to use a face recognition algorithm to recognize the original image and obtain an effective image containing face features.

The effective image cutting module 30 is configured to use a preset selection box to cut out a target facial image from the effective image.

Further, the original image crawling module 10 includes a web address crawling unit 11, a web address storage unit 12, and an image downloading unit 13.

The web address crawling unit 11 is configured to crawl a web address of the original image from the network by using a web crawler.

The web address storage unit 12 is configured to store the web address in a to-be-downloaded message queue.

The image downloading unit 13 is configured to use an image downloading tool to crawl the original image from a web corresponding to the web address in the to-be-downloaded message queue.

Further, the effective image recognition module 20 includes a facial feature determination unit 211, an integrity of a facial feature determination unit 212, and a first image capturing unit 213.

The facial feature determination unit 211 is configured to use the face recognition algorithm to recognize the original image to determine whether there is a facial feature in the original image.

The integrity of a facial feature determination unit 212 is configured to obtain an integrity of the facial feature in the original image if there is the facial feature in the original image, and determine whether the integrity of the facial feature reaches a predetermined integrity.

The first image capturing unit 213 is configured to use the original image as the effective image containing the face features if the integrity of the facial feature reaches the predetermined integrity.

Further, the effective image recognition module 20 includes a face region recognition unit 221, an image proportion determination unit 222, and a second image capturing unit 223.

The face region recognition unit 221 is configured to use the face recognition algorithm to recognize the original image to determine whether there is a face region in the original image.

The image proportion determination unit 222 is configured to calculate a proportion of a facial image when there is the face region in the original image, and determine whether the proportion of the facial image is greater than a preset proportion.

The second image capturing unit 223 is configured to use the original image as the effective image containing the face features when the proportion of the facial image is greater than the preset proportion.

Further, the effective image cutting module 30 includes an initial image cutting unit 31, an image pixel obtaining unit 32, an image pixel determining unit 33, and a target image obtaining unit 34.

The initial image cutting unit 31 is configured to use the preset selection box to cut out an initial facial image containing the face features from the effective image.

The image pixel obtaining unit 32 is configured to obtain an actual pixel value of the initial facial image.

The image pixel determining unit 33 is configured to determine whether the actual pixel value is greater than a preset pixel value.

The target image obtaining unit 34 is configured to use the initial facial image as the target facial image if the actual pixel value is greater than the preset pixel value.

In the facial image data collection apparatus provided in this embodiment, the original image crawling module 10 uses an image crawler tool to crawl the original image from the network, and can automatically capture the original image from the network according to a certain rule, and does not need to use a camera or webcam to capture images or video streams containing faces, thereby improving the efficiency of image capturing and reducing costs. The effective image recognition module 20 uses a face recognition algorithm to recognize the original image and obtains an effective image containing the face features. The algorithm can automatically detect and recognize the face in the image, and further confirm the face features of the detected face. The effective image cutting module 30 cuts out the target facial image from the effective image by using the preset selection box, and can clearly and completely cut out the facial image.

### Embodiment 3

This embodiment provides a computer readable storage medium on which computer readable instructions are stored. When the computer readable instructions are executed by a processor, the facial image data collection method in Embodiment 1 is implemented. Details are not described again herein so as to avoid repetition. Alternatively, when the computer readable instructions are executed by the processor, the functions of the modules/units in the facial image data collection apparatus in Embodiment 2 are implemented. Details are not described again herein so as to avoid repetition.

### Embodiment 4

FIG. 7 is a schematic diagram of a terminal device in this embodiment. As shown in FIG. 7, the terminal device 70 includes a processor 71, a storage 72, and computer readable instructions 73 stored in the storage 72 and operable on the processor 71. When the processor 71 executes the computer readable instructions 73, it implements various steps of the facial image data collection method in Embodiment 1, such as steps S10, S20, and S30 shown in FIG. 1. Alternatively, when the processor 71 executes the computer readable instructions 73, the functions of the modules/units of the facial image data collection apparatus in Embodiment 2 are implemented, such as the functions of the original image crawling module 10, the effective image recognition module 20, and the effective image cutting module 30, as shown in FIG. 6.

Exemplarily, the computer readable instructions 73 may be partitioned into one or more modules/units, and the one or more modules/units are stored in the storage 72 and executed by the processor 71 to complete the present application. The one or more modules/units may be instruction segments of a series of computer readable instructions 73 capable of performing a specific function, and the instruction segments may describe the execution of the computer readable instructions 73 in the terminal device 70. For example, the computer readable instructions 73 may be partitioned into the original image crawling module 10, the effective image recognition module 20, and the effective image cutting module 30 shown in FIG. 6.

The original image crawling module 10 is configured to use an image crawler tool to crawl an original image from a network.

The effective image recognition module 20 is configured to use a face recognition algorithm to recognize the original image and obtain an effective image containing face features.

The effective image cutting module 30 is configured to use a preset selection box to cut out a target facial image from the effective image.

Further, the original image crawling module 10 includes a web address crawling unit 11, a web address storage unit 12, and an image downloading unit 13.

The web address crawling unit 11 is configured to crawl a web address of the original image from the network by using a web crawler.

The web address storage unit 12 is configured to store the web address in a to-be-downloaded message queue.

The image downloading unit 13 is configured to use an image downloading tool to crawl the original image from a web corresponding to the web address in the to-be-downloaded message queue.

Further, the effective image recognition module 20 includes a facial feature determination unit 211, an integrity of a facial feature determination unit 212, and a first image capturing unit 213.

The facial feature determination unit 211 is configured to use the face recognition algorithm to recognize the original image to determine whether there is a facial feature in the original image.

The integrity of a facial feature determination unit 212 is configured to obtain an integrity of the facial feature in the original image if there is the facial feature in the original image, and determine whether the integrity of the facial feature reaches a predetermined integrity.

The first image capturing unit 213 is configured to use the original image as the effective image containing the face features if the integrity of the facial feature reaches the predetermined integrity.

Further, the effective image recognition module 20 includes a face region recognition unit 221, an image proportion determination unit 222, and a second image capturing unit 223.

The face region recognition unit 221 is configured to use the face recognition algorithm to recognize the original image to determine whether there is a face region in the original image.

The image proportion determination unit 222 is configured to calculate a proportion of a facial image when there is the face region in the original image, and determine whether the proportion of the facial image is greater than a preset proportion.

The second image capturing unit 223 is configured to use the original image as the effective image containing the face features when the proportion of the facial image is greater than the preset proportion.

Further, the effective image cutting module 30 includes an initial image cutting unit 31, an image pixel obtaining unit 32, an image pixel determining unit 33, and a target image obtaining unit 34.

The initial image cutting unit 31 is configured to use the preset selection box to cut out an initial facial image containing the face features from the effective image.

The image pixel obtaining unit 32 is configured to obtain an actual pixel value of the initial facial image.

The image pixel determining unit 33 is configured to determine whether the actual pixel value is greater than a preset pixel value.

The target image obtaining unit 34 is configured to use the initial facial image as the target facial image if the actual pixel value is greater than the preset pixel value.

The terminal device 70 may be a computing device such as a desktop computer, a laptop, a handheld computer, and a cloud server. The terminal device may include, but is not limited to the processor 71 or the storage 72. Those skilled in the art can understand that FIG. 6 is merely an example of the terminal device 70 and does not constitute a limitation of the terminal device 70. It may include more or less than the illustrated components, or combine some components, or include different components. For example, the terminal device may also include an input and output device, a network access device, a bus, and the like.

The mentioned processor 71 may be a central processing unit (CPU), and may also be a general-purpose processor, a Digital Signal Processor (DSP), or an Application Specific Integrated Circuit (ASIC), a Field-Programmable Gate Array (FPGA) or other programmable logic devices, discrete gate or transistor logic devices, discrete hardware components, and the like. A general purpose processor may be a microprocessor or the processor may be any conventional processor or the like.

The storage 72 may be an internal storage unit of the terminal device 70, such as a hard disk or the memory of the terminal device 70. The storage 72 may also be an external storage device of the terminal device 70, such as a plug-in hard disk equipped on the terminal device 70, a smart media card (SMC), a secure digital (SD) card, a flash card, etc. Further, the storage 72 may also include both the internal storage unit and the external storage device of the terminal device 70. The storage 72 is used to store computer readable instructions 73 as well as other programs and data required by the terminal device. The storage 72 may also be used to temporarily store data that has been output or will be output.

Those skilled in the art can clearly understand that, for the convenience and conciseness of the description, the division of the above functional units and modules is only used as an example for illustration. In practical applications, the above functions may be assigned to different functional units or modules to implement according to needs. That is, the internal structure of the device is divided into different functional units or modules to implement all or some of the functions described above. Each functional unit and module in the embodiments may be integrated in one processing unit, or each functional unit may be a separate physical unit, or two or more above units may be integrated in one unit. The above-mentioned integrated unit may be implemented in the form of hardware or also be implemented in the form of software functional units. In addition, the specific names of the functional units and modules are only for distinguishing from each other and are not used to limit the protection scope of the present application. The specific working process of the units and modules in the foregoing system can refer to corresponding processes in the foregoing method embodiments, and details are not described herein again.

In the foregoing embodiments, the description of each embodiment has its own emphasis. For the part that is not mentioned or not described in detail in an embodiment, reference may be made to the relevant description in other embodiments.

Those of ordinary skill in the art may be aware that the exemplary units and algorithm steps described in conjunction with the embodiments disclosed herein can be implemented by electronic hardware or a combination of computer software and electronic hardware. Whether these functions are implemented in hardware or software depends on the specific application of the technical solution and design constraint conditions. A person skilled in the art may use different methods to implement the described functions for each specific application, but such implementation should not be considered to be beyond the scope of the present application.

In the embodiments provided by the present application, it should be understood that the disclosed apparatus/terminal devices and methods may be implemented in other manners. For example, the apparatus/terminal device embodiments described above are merely illustrative. For example, the division of the modules or units may be only one kind of logical function division. In practice, there may be other division manners. For example, multiple units or components can be combined or can be integrated into another system, or some features can be ignored or not performed. In addition, the illustrated or discussed coupling, direct coupling or communication connection may be through some interfaces. Indirect coupling or communication connection between devices or units may be electrical, mechanical or other forms.

The units described as separate parts may or may not be physically separated, and the parts displayed as units may or may not be physical units. That is, they may be located in one place, or may be distributed on multiple network units. Some or all of the units may be selected according to actual needs to achieve the purpose of the solution of this embodiment.

In addition, each functional unit in each embodiment of the present application may be integrated in one processing unit, or each functional unit may be a separate physical unit, or two or more above units may be integrated in one unit. The above-mentioned integrated unit may be implemented in the form of hardware or also be implemented in the form of software functional units.

The integrated modules/units, if implemented in the form of software functional units and sold or used as independent products, may be stored in a computer readable storage medium. Based on such understanding, the present application implements all or part of the processes in the foregoing method embodiments, and may also be implemented by using computer readable instructions to instruct related hardware. The computer readable instructions may be stored in a computer readable storage medium. In the above, the computer readable instructions, when executed by a processor, can implement the steps of the foregoing method embodiments. Where, the computer readable instructions include computer readable instruction code, and the computer readable instruction code may be in source code form, object code form, executable file or some intermediate form, or the like. The computer readable medium may include any entity or device capable of carrying the computer readable instruction code, a recording medium, a USB flash drive, a removable hard disk, a magnetic disk, an optical disk, a computer memory, a Read-Only memory (ROM), a Random Access Memory (RAM), electrical carrier signals, telecommunications signals, and software distribution media. It should be noted that the contents contained in the computer readable medium can be appropriately increased or decreased according to the requirements of legislation and patent practice in the jurisdiction. For example, in some jurisdictions, according to legislation and patent practice, the computer readable medium may not include electrical carrier signals and telecommunication signals.

The above described embodiments are only used to illustrate the technical solutions of the present application, rather than limiting the same. Although the present application has been described in detail with reference to the foregoing embodiments, those of ordinary skill in the art should understand that the technical solutions described in the aforementioned various implementations can still be modified or some of the technical features can be equivalently replaced. These modifications or replacements do not make the nature of the corresponding technical solutions deviate from the spirit and scope of the technical solutions in the embodiments of the present application and should be within the scope of the application.

1. A facial image data collection method, comprising:
crawling an original image from a network by using an image crawler tool;
recognizing the original image to obtain an effective image containing face features by using a face recognition algorithm; and
cutting out a target facial image from the effective image by using a preset selection box.

2. The facial image data collection method of claim 1, wherein the step of recognizing the original image to obtain the effective image containing the face features by using the face recognition algorithm comprises:
recognizing the original image to determine whether the original image comprises a facial feature by using the face recognition algorithm;
obtaining an integrity of the facial feature in the original image upon a condition that the original image comprises the facial feature;
determining whether the integrity of the facial feature reaches a predetermined integrity; and
determining the original image as the effective image containing the face features upon a condition that the integrity of the facial feature reaches the predetermined integrity.

3. The facial image data collection method of claim 1, wherein the step of recognizing the original image to obtain the effective image containing the face features by using the face recognition algorithm comprises:
recognizing the original image to determine whether the original image comprises a face region by using the face recognition algorithm;
calculating a proportion of a facial image upon a condition that the original image comprises the face region;
determining whether the proportion of the facial image is greater than a preset proportion; and
determining the original image as the effective image containing the face features upon a condition that the proportion of the facial image is greater than the preset proportion.

4. The facial image data collection method of claim 1, wherein the step of cutting out the target facial image from the effective image by using the preset selection box comprises:
cutting out an initial facial image containing the face features from the effective image by using the preset selection box;
obtaining an actual pixel value of the initial facial image;
determining whether the actual pixel value is greater than a preset pixel value; and
determining the initial facial image as the target facial image upon a condition that the actual pixel value is greater than the preset pixel value.

5. The facial image data collection method of claim 1, wherein the step of crawling the original image from the network by using the image crawler tool comprises:
crawling a web address of the original image from the network by using a web crawler;
storing the web address in a to-be-downloaded message queue;
crawling the original image from a web corresponding to the web address in the to-be-downloaded message queue by using an image downloading tool.

6. A facial image data collection apparatus, comprising:
an original image crawling module configured to use an image crawler tool to crawl an original image from a network;
an effective image recognition module configured to use a face recognition algorithm to recognize the original image and obtain an effective image containing face features; and
an effective image cutting module configured to use a preset selection box to cut out a target facial image from the effective image.

7. The facial image data collection apparatus of claim 6, wherein the effective image recognition module comprises:
a facial feature determination unit configured to use the face recognition algorithm to recognize the original image to determine whether the original image comprises a facial feature;
an integrity of a facial feature determination unit configured to obtain an integrity of the facial feature in the original image upon a condition that the original image comprises the facial feature, and determine whether the integrity of the facial feature reaches a predetermined integrity; and
a first image capturing unit configured to determine the original image as the effective image containing the face features upon a condition that the integrity of the facial feature reaches the predetermined integrity.

8. The facial image data collection apparatus of claim 6, wherein the effective image recognition module comprises:
a face region recognition unit configured to use the face recognition algorithm to recognize the original image to determine whether the original image comprises a face region;
an image proportion determination unit configured to calculate a proportion of a facial image upon a condition that the original image comprises the face region, and determine whether the proportion of the facial image is greater than a preset proportion; and
a second image capturing unit configured to determine the original image as the effective image containing the face features upon a condition that the proportion of the facial image is greater than the preset proportion.

9. The facial image data collection apparatus of claim 6, wherein the original image crawling module comprises:
a web address crawling unit configured to crawl a web address of the original image from the network by using a web crawler;
a web address storage unit configured to store the web address in a to-be-downloaded message queue;
an image downloading unit configured to use an image downloading tool to crawl the original image from a web corresponding to the web address in the to-be-downloaded message queue.

10. The facial image data collection apparatus of claim 6, wherein the effective image cutting module comprises:
an initial image cutting unit configured to use the preset selection box to cut out an initial facial image containing the face features from the effective image;
an image pixel obtaining unit configured to obtain an actual pixel value of the initial facial image;
an image pixel determining unit configured to determine whether the actual pixel value is greater than a preset pixel value; and
a target image obtaining unit configured to determine the initial facial image as the target facial image upon a condition that the actual pixel value is greater than the preset pixel value.

11. A terminal device comprising a storage, a processor, and computer readable instructions stored in the storage and executable on the processor, wherein the processor executes the computer readable instructions to implement following steps:
crawling an original image from a network by using an image crawler tool;
recognizing the original image to obtain an effective image containing face features by using a face recognition algorithm; and
cutting out a target facial image from the effective image by using a preset selection box.

12. The terminal device of claim 11, wherein the step of recognizing the original image to obtain the effective image containing the face features by using the face recognition algorithm comprises:
recognizing the original image to determine whether the original image comprises a facial feature by using the face recognition algorithm;
obtaining an integrity of the facial feature in the original image upon a condition that the original image comprises the facial feature;
determining whether the integrity of the facial feature reaches a predetermined integrity; and
determining the original image as the effective image containing the face features upon a condition that the integrity of the facial feature reaches the predetermined integrity.

13. The terminal device of claim 11, wherein the step of recognizing the original image to obtain the effective image containing the face features by using the face recognition algorithm comprises:
recognizing the original image to determine whether the original image comprises a face region by using the face recognition algorithm;
calculating a proportion of a facial image upon a condition that the original image comprises the face region;
determining whether the proportion of the facial image is greater than a preset proportion; and
determining the original image as the effective image containing the face features upon a condition that the proportion of the facial image is greater than the preset proportion.

14. The terminal device of claim 11, wherein the step of cutting out the target facial image from the effective image by using the preset selection box comprises:
cutting out an initial facial image containing the face features from the effective image by using the preset selection box;
obtaining an actual pixel value of the initial facial image;
determining whether the actual pixel value is greater than a preset pixel value; and
determining the initial facial image as the target facial image upon a condition that the actual pixel value is greater than the preset pixel value.

15. The terminal device of claim 11, wherein the step of crawling the original image from the network by using the image crawler tool comprises:
crawling a web address of the original image from the network by using a web crawler;
storing the web address in a to-be-downloaded message queue;
crawling the original image from a web corresponding to the web address in the to-be-downloaded message queue by using an image downloading tool.

16-20. (canceled)
